(19) United States
(12) Patent Application Publication
(10) Pub. No.: US 2016/0227813 A1
(43) Pub. Date: Aug. 11, 2016

(54) PROCESS FOR MAKING CONFECTIONS

(71) Applicant: MARS, INCORPORATION, McLean, VA (US)

(72) Inventors: ANDREA CATTARUZA, SLOUGH (GB); ROWENA JANE SHONILA NEWTON, SLOUGH (GB); ROBERT DAVID MANNM, SLOUGH (GB)

(73) Assignee: Mars, Incorporated, McLean, VA (US)

(21) Appl. No.: 15/088,515

(22) PCT Filed: Oct. 3, 2014
(86) PCT No.: PCT/US14/59059

§ 371 Date: Apr. 1, 2016

Related U.S. Application Data
(60) Provisional application No. 61/886,888, filed on Oct. 4, 2013.

(51) Int. Cl. A23G 3/02

(52) U.S. Cl. CPC A23G 3/0226; A23L 1/025; A23V 2002/00

(57) ABSTRACT

A system for manipulating the viscosity of confection compositions is provided including an electrical field generator, an electrical field applicator, and a viscosity manipulation chamber; wherein the electrical field generator generates an electrical field with a strength of from about 3 kilovolts/cm to about 25 kilovolts/cm; and wherein the electrical field applicator applies the electrical field to the viscosity manipulation channel continuously and in a direction that is parallel or perpendicular to a flow of a confection composition located in the viscosity manipulation chamber; and wherein the confection composition has a protein content of from about 4% to about 9%. Confection compositions manipulated according to the system of the invention have an average particle size of between about 0.1 and 100 micrometers.

### FIELD

The present invention relates to systems and processes for making, or treating, confections.

### BACKGROUND

The manufacture of confections can be a complicated and expensive process at least because many of the components utilized are sensitive to the processing conditions required to manipulate them into their desired format. For example, in certain processing steps, confections and/or components thereof, may desirably be fluid, while in others, gelation or even solidification can be desired. Indeed, viscosity and/or rheology manipulation is critical at many steps of the manufacturing process.

Conventional methods of controlling or manipulating viscosity include application, or removal, of heat, altering the composition of the confection or mechanically altering the rheology of the composition through pumping or stirring. Each of these can be suboptimal in certain applications.

For example, application of excessive heat can result in the confection exhibiting unsatisfactory sensory attributes, such as diminished texture, mouth feel, appearance or flavor. Altering the composition of the confection may also assist in maintaining a desired, and processable, viscosity, but doing so may also undesirably alter the flavor profile of the confection. Mechanically adjusting the rheology or viscosity of the confection or components thereof can require capital expenditure for suitable equipment to do so, as well as the manufacturing space and utility cost of operating the same, not to mention the time such steps can require.

It would thus be of benefit to those operating in the art of confectionery manufacture to have a means to alter the viscosity, rheology or flow properties of a confection, or components thereof, without the need to adjust the temperature or the composition of the confection. Further advantage would be provided if any such method could be implemented with minimal disruption to a conventional process for the manufacture of the confection, i.e., with minimal additional time, cost, and/or space requirements.

### BRIEF DESCRIPTION

The present invention provides a method of controlling or altering the rheology or viscosity of fluid confections without the application of heat and without changing the chemical composition. Through application of this technology, the baking and confection industry can control the flow properties of fluid confections such as chocolate, caramel, and sugar solutions and suspensions without worry of introducing deleterious sensory attributes into the candy. Controlling the heat transfer properties of fluid foods with an electric field can have a significant impact on a food process design.

In one aspect, a process for making a confection comprising exposing the confection, or a precursor thereof, to electromagnetic radiation is disclosed. The confection may be a fluid, such as a liquid, or may be a solid. Examples of confections that could benefit from application of the present method include, but are not limited to chocolate, caramel, cocoa liquor, sugar solution, sugar suspension or combinations thereof. The electromagnetic radiation can be used to alter the rheological characteristics of the confection or confection precursor, and in some embodiments, can be used to manipulate the viscosity of the confection, i.e., by increasing or decreasing it.

In some embodiments, benefits may be realized by applying a continuous direct or alternating current electric field at a strength of from about 2-5 Kilovolt/cm. In another embodiment, benefits may be realized by applying a continuous direct current electric field at a strength of from about 10-25 Kilovolt/cm. In yet another embodiment, benefits may be realized by applying a pulsed alternating current electric field at a strength of from about 2-5 Kilovolt/cm. In yet another embodiment, benefits may be realized by applying a continuous alternating current electric field at a strength of from about 2-5 Kilovolt/cm. When the electric radiation is pulsed it may be applied for a first time period and then discontinued for a second time period. In such embodiments, the first and second time periods may be the same or different and the pulses repeated any number of times. Such pulses may be lower frequency of less than 100 Hz or may be higher frequency of greater than 100 Hz.

In some embodiments, benefits may be realized by applying a continuous direct or alternating current magnetic field at a strength of from about 0.01-2 Tesla. In another embodiment, benefits may be realized by applying a pulsed direct current magnetic field at a strength of from about 0.01-2. Tesla. In yet another embodiment, benefits may be realized by applying a pulsed alternating current magnetic field at a strength of from about 0.01-2 Tesla. When the electromagnetic radiation is pulsed it may be applied for a first time period and then discontinued for a second time period, in such embodiments, the first and second time periods may be the same or different and the pulses repeated any number of times. Likewise, the second and third pulses may be the same or different than the first and second pulses. Such pulses may be lower frequency of less than 100 micro seconds to 100 seconds or may be higher frequency of greater than 100 seconds.

In some embodiments, the radiation exposure may cause the particles within the confection to form aggregates of particles within the field, in a size and number such that viscosity of the confection, or confection precursor, is reduced. In some embodiments, the radiation exposure may cause the particles within the confection to form aggregates of particles within the field, in a size and number such that viscosity of the confection, or confection precursor, is increased.

In some embodiments, the electromagnetic radiation exposure may depend upon the size and content of the particles in the confection. In the case of high protein particles having large particle size a direct current, high or low strength continuous or pulsed source of radiation may be applied. In the case of high protein particles having small particle size a direct current, high or low strength continuous or pulsed source of radiation may be applied. In the case of low protein particles having large particle size a direct current, high or low strength continuous or pulsed source of radiation may be applied, in the case of low protein particles having small particle size a direct current, high or low strength continuous or pulsed source of radiation may be applied. Such radiation source may be in a parallel or in a perpendicular orientation in relation to the flow of the confection, or in an embodiment, the chocolate composition. For the purposes of this invention, it is expected that particles having an average particle size ranging from 0.1 to 100 microns will respond most favorably to radiation exposure. That is, compositions having average particle sizes within the range of 0.1 to 100 microns will respond to viscosity manipulation via electromagnetic radiation. For the purposes of this invention, small particles are those ranging in diameter from 0.1 to 50 microns and large particles are those ranging in diameter from 51 to about 100 microns.

In another aspect, an apparatus for processing a confection is provided. The apparatus comprises a conduit or conveyance for transporting, or a vessel for housing, the confection. At least one, and in some embodiments, a plurality of devices for producing electromagnetic radiation are provided and are operably disposed relative to the conduit, conveyance or vessel. The devices comprise electrodes, leads, webbing, electromagnets, or a combination of these. The field strength applied by each device may be the same or different.

### DETAILED DESCRIPTION

The present specification provides certain definitions and methods to better define the present invention and to guide those of ordinary skill in the art in the practice of the present invention. Provision, or lack of the provision, of a definition for a particular term or phrase is not meant to imply any particular importance, or lack thereof. Rather, and unless otherwise noted, terms are to be understood according to conventional usage by those of ordinary skill in the relevant art.

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation.

If ranges are disclosed, the endpoints of all ranges directed to the same component or property are inclusive and independently combinable (e.g., ranges of “up to 25 wt. %, or, more specifically, 5 wt. % to 20 wt. %,” is inclusive of the endpoints and all intermediate values of the ranges of “5 wt % to 25 wt. %,” etc.). As used herein, percent (%) conversion is meant to indicate change in molar or mass flow of reactant in a reactor in ratio to the incoming flow, while percent (%) selectivity means the change in molar flow rate of product in a reactor in ratio to the change of molar flow rate of a reactant.

As used herein, weight percent (wt %), percent by weight, % by weight, and the like are synonyms that refer to the concentration of a substance as the weight of that substance divided by the total weight of the composition and multiplied by 100. All compositional ratios are provided as weight percentages unless otherwise stated.

Reference throughout the specification to “one embodiment” or “an embodiment” means that a particular feature, structure, or characteristic described in connection with an embodiment is included in at least one embodiment. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The present invention contemplates the possibility of omitting any components or steps listed herein. The present invention further contemplates the omission of any components or steps even though they are not expressly named as included or excluded from the invention.

The term “about,” as used herein, refers to variations in the numerical quantity that can occur, for example, through typical measuring and liquid handling procedures used for making compositions; through inadvertent error in these procedures; through differences in the manufacture, source, or purity of the ingredients employed to make the compositions or carry out the methods; and the like. The term “about” also encompasses the degree of error associated with measurement of the particular quantity.

As used herein the term, “consisting essentially of” in reference to a composition refers to the listed ingredients and does not include additional ingredients that, if present, would affect the taste or processability of the confection composition. The term “consisting essentially of” may also refer to a system for manipulating the viscosity of a confection composition. As used herein the term “consisting essentially of” in reference to a system of manipulating viscosity of a confection composition refers to the listed components and/or steps and does not include additional steps (or ingredients if a composition is included in the system) that, if present, would affect the handle-ability or the taste of the confection composition.

“Fluid” as referred to herein refers to a continuous, amorphous confection whose molecules move freely past one another and that has the tendency to assume the shape of its container. For purposes of the invention a “fluid” substance is a liquid.

The term “confection composition” or “confection” as used herein may refer to fluid confections such as chocolate, caramel, nougat, compound coatings, fillings, and sugar suspensions. “Confection compositions” of the invention include a fat continuum that supports solid phase particles of the confection composition. A confection composition according to the invention includes between about 20 and 40 percent of the fat continuum. In some embodiments, confection compositions according to the invention include about 25 to 40 weight percent fat, between about 25 to 35 weight percent fat. The fat continuum may be comprised of any combination of cocoa butter, vegetable fats, and anhydrous milk fat (“AMF”). The fat continuum supports a particulate solid phase in the amount of between about 60 to 80 weight percent of the confection composition 65 to 75 weight percent, 70 to 80 weight percent. The solids phase of “confection compositions” is comprised of particles including any combination of sugar, non fat cocoa solids, proteins, sweeteners and fiber.

The term “electromagnetic radiation” as used herein refers to either an electric field or a magnetic field or both and may be supplied in any suitable format, such as via electric field, a magnetic field, an electromagnetic field, or a combination of these. Electromagnetic fields, for example, can be generated by creating a potential across a conduit, or other conveyance, comprising the confection by any suitable means, including via a capacitor. One skilled in the art will recognize that electricity may be used to generate a magnetic field or an electric field, or both.

As used herein, the term “parallel” when referring to the direction of the electromagnetic field refers to a field that lies in the direction of the flow of the fluid confection composition. The term “perpendicular” refers to a field that is crosswise to the direction of the flow of the confection composition.

The solid phase may include solid particles having an average particle size of between about 0.1 to about 100 microns, between about 0.5 and about 90 microns, between about 1-80 microns, between about 5-70 microns, between about 10-60 microns, between about 10-30 microns depending upon the confection type (white, milk, or dark chocolate, compound coating, caramel to name a few) but may include particles having up to about 300 microns in diameter. Such large particles may be the case if granulated sugar is suspended in the flit continuum of a confection composition of the invention.

Without being bound by theory it is believed that particles that are less than 0.1 microns are too small and exhibit too much Brownian motion to become arranged in a manner that allows manipulation of the viscosity of the overall fluid in accordance with the invention. It is further believed that particles that are too large are not able to fibrillate in an electromagnetic field to allow them to be arranged in a manner to allow manipulation of the overall fluid in which they are located.

The shape of the suspended solid particles in a confection composition may have an impact upon the ability to manipulate the viscosity of the confection composition. It is hypothesized that jagged or flaked particles are more suitable for manipulating the viscosity or rheology of the confection composition in which they reside as opposed to spherical or globular particles.

Confection compositions of the invention include about 1 to about 12 weight percent protein, about 1.5 to about 10 weight percent protein, about 3 to 9, about or about 5 to about 8.5 weight percent protein. Protein is found in the solids phase of the confection composition and may be comprised of milk proteins as an example.

The present invention provides a process for making a confection comprising exposing the confection, or confection precursor, to an electromagnetic field. This exposure may be used to alter the rheological properties of the confection or precursor, e.g., the exposure may be used to alter the viscosity of the confection composition or precursor. While not wishing to be bound by any theory, it is believed that when an electric or field is applied to such confections or precursors in a fluid state, polar particles within the confection or precursor thereof link together to form chains. These chains are then believed to orient themselves to be parallel with the applied field. This orientation, in turn, is believed to increase the directional thermal conductivity of such fluids, providing a direct path for energy transfer through the material.

While electrorheology has been tested with respect to altering the rheology of petroleum and crude oil, raw materials are extremely different compositions than confections. For one, confections are blends of many complex components, any one of them capable of shielding the others from the effects of electromagnetic radiation. And, while petroleum or crude oil does not separate when subjected to increased temperatures, confections are extremely sensitive to the same, and may separate, seize, or acquire a burned flavor at high temperatures. Furthermore, it has been reported that applying electric fields to petroleum results in gelling or thickening of the petroleum. In contrast, applying electromagnetic fields to crude oil has resulted in thinning of the crude oil. And so, even in these electrorheological fluids, the effect of electromagnetic radiation is not guaranteed, and those of ordinary skill would not consider applying it to a confection out of concern that the effect, if any, would be undesirable, or even detrimental.

It has now been surprisingly discovered that the application of electromagnetic radiation can successfully be used in the processing of confections, to alter the rheological properties thereof. Furthermore, such application does not result in the overheating or seizing of the chocolate, nor does it impart an off flavor to the resulting confection. Indeed, the effects of exposure to electromagnetic radiation can be temporary and reversible. And, electromagnetic radiation may easily and inexpensively be incorporated into confectionery manufacturing processes, inasmuch as equipment for generating such fields is readily commercially available and typically, capable of being manipulated to surround, or otherwise be operably disposed relative to the confection.

The confection, or precursor, may be in any format, whether it be solid, gelled, fluid when contacted with the electromagnetic radiation. For example, solid confections or precursors thereof may be in contact with electromagnetic radiation for a period of time sufficient to alter the rheology of any liquid components thereof. In those embodiments, wherein the confection or precursor comprises a fluid, the electromagnetic radiation may advantageously be used to manipulate, to reduce or increase, the viscosity of the fluid.

While the process is applicable to any confection or precursor, in any format, particular advantage can be seen when the process is applied to fluids which are too viscous, due at least in part to temperature considerations or compositional considerations, to be easily transported or piped from one location to another during processing such may be the case with chocolate compositions. In such embodiments, application of an electromagnetic field to the confection can be used to reduce the viscosity of the confection so that flow of the confection through the process is facilitated and/or to reduce, or eliminate, the precipitation of solids which might cause blockage or reduced flow through conduits through which the confection must pass. A fluid confection having a lower viscosity is easier to transport from one mixing apparatus to another or to deposit into molds. In contrast, it may be desirable to increase the viscosity of chocolate if it is being used to enrobe a product such that all the chocolate does not flow off the product before setting.

As one skilled in the art will recognize, the strength of the electromagnetic field to be applied and duration of application will depend on the composition of the confection or precursor, the desired degree of viscosity alteration desired (decreased or increased), the temperature of the confection fluid, and the period during which the field is to be applied. If the field strength is too low or the application period too short, an insignificant change in viscosity may result Conversely, if the strength of the field is too high or the period of application too long, the viscosity of the fluid may increase, which may be desirable in some embodiments, but unexpected or undesired in others. In some embodiments, it may be the case that the higher the initial viscosity of the fluid before being subjected to the field, the greater the reduction in viscosity after being subjected to the field. On the other hand, the lower the initial viscosity of the confection fluid before being subjected to the field, the greater the increase in viscosity after being subjected to the field.

Whether or not the viscosity of the confection composition is increased or decreased may depend upon the directional application of the field and the type of field generated. That is, it is hypothesized that a field generated in a direction parallel to the flow of the confection would result in decreased viscosity whereas if the field is generated perpendicular to the flow it may increase the viscosity.

It may be that certain confection compositions respond better to electric fields while others respond better to magnetic fields. Without wishing to be bound by theory it is believed that those confection compositions including paramagnetic particles respond better to magnetic fields while those without paramagnetic particles do not respond as well to magnetic fields. Magnetic fields do appear to affect viscosity and rheology of tempered chocolate confections.

In the event that electric fields are used in the process of the invention, benefits may be realized with direct or alternating currents, or a combination thereof. The invention may employ an electric field at a strength of from about 2-5 Kilovolt/cm. In another embodiment, benefits may be realized by applying a continuous direct current electric field at a strength of from about 10-25 Kilovolt/cm. In yet another embodiment, benefits may be realized by applying a pulsed alternating current electric field at a strength of from about 2-5 Kilovolt/cm. In yet another embodiment, benefits may be realized by applying a continuous alternating current electric field at a strength of from about 2-5 Kilovolt/cm. When the electric radiation is pulsed it may be applied for a first time period and then discontinued for a second time period. In such embodiments, the first and second time periods may be the same or different and the pulses repeated any number of times. Likewise, the second and third pulses may be the same or different than the first and second pulses. Such pulses may be of lower frequency of less than 100 Hz or may be higher frequency of greater than 100 Hz.

In the event that a magnetic field is used fir the process of the invention, benefits may again be realized with direct or alternating currents, or a combination thereof. In some embodiments, benefits may be realized by applying a continuous direct or alternating current magnetic field at a strength of from about 0.01-2 Tesla. In another embodiment, benefits may be realized by applying a pulsed direct current magnetic field at a strength of from about 0.01-2 Tesla. In yet another embodiment, benefits may be realized by applying a pulsed alternating current magnetic field at a strength of from about 0.01-2 Tesla. When the magnetic radiation is pulsed it may be applied for a first time period and then discontinued for a second time period. In such embodiments, the first and second time periods may be the same or different and the pulses repeated any number of times. Likewise, the second and third pulses may be the same or different than the first and second pulses. Such pulses may be lower frequency of greater than 100 seconds or may be higher frequency of less than 100 micro seconds.

The invention anticipates that electric and magnetic fields may each be used exclusively in a process or may be used in tandem when processing the same confection composition. A certain type of electromagnetic radiation in one direction may be beneficial at one point in the processing of a confection while another type of electromagnetic radiation in another direction may be beneficial at another point in the processing of the same confection composition. It might be the case that an electric field is used on a chocolate composition before tempering while a magnetic field might be used on the same chocolate composition after tempering or vice versa. One type of electromagnetic radiation may be used upstream while another type of electromagnetic radiation may be used downstream. The invention also anticipates that both electric and magnetic radiation may be applied to a confection composition at the same lime or sequentially.

A direct current (DC) or an alternating current (AC) may be used to generate the electric/magnetic field. When applying an electric field, the applied field is in the range of about 1 to about 25 KiloVolt/cm. In an embodiment the field strength is 2-5 KiloVolt/cm. In another embodiment the field strength is 10-25 KiloVolt/cm. When applying a magnetic field, the applied field is in the range of about 0.01 to about 2 Tesla. In an embodiment the field strength is 0.01-0.5 Tesla. In another embodiment the field strength is in the range of 00.5-2 Tesla. Either or both types of electromagnetic energy may be applied in a direction parallel to the direction of the flow of the confection fluid or may lie applied perpendicular to the direction of the flow of the confection fluid.

When the electrical field is pulsed, the electrical field may be applied to the viscosity manipulation chamber as pulses occurring with a frequency of 1 to 60 pulses every second for from about 10 to about 15 seconds. The frequency of the pulses may be about 2 to 20 every second, about 2 to 10 every second, about 2 or 3 every second. One skilled in the art will recognize that the rate of flow of the confection composition will affect the frequency of the pulses. That is, if the rate of flow is faster, the frequency of the pulses may increase or decrease. Likewise, the duration of the pulses may increase or decrease depending upon the flow rate of the confection composition.

The invention contemplates that a controller may be used to control the power supply that is generating the electromagnetic field. A sensor may be used to sense the viscosity of the confection composition. The sensor may provide feedback to the controller to increase or decrease the intensity of the field or to alter the direction of the applied field relative to the flow of the confection composition or to pulse the field or to increase or decrease the frequency or duration of pulses of energy.

The table provided below includes the different variables the invention envisions as possible and useful when manipulating the viscosity of a confection composition using an electric field along with the expected effect.

| Electric Field | | | | | |
|---|---|---|---|---|---|
| | | Electric | | | |
| | Electric | field | | | |
| Electric | field | application | Pulse | Electric field | Expected |
| field type | strength | duration | frequency | orientation | Effect |
| DC or AC | Lower: 2-5 Kilovolt/cm | Continuous | Lower: | Perpendicular | Increase in |
| | | | <100 Hz | to flow | viscosity due |
| | | | | | to electro- |
| | | | | | rheological |
| | | | | | effect |
| DC | Higher: 10-25 Kilovolt/cm | Continuous | n/a | Perpendicular | Decrease in |
| | | | | to flow and | viscosity due |
| | | | | parallel to | to Quincke |
| | | | | velocity | rotation* |
| | | | | gradient | |
| DC | Higher: 10-25 kilovolt/cm | Pulsed | Single pulse | Parallel to | Decrease in |
| | | | of duration | flow | viscosity due |
| | | | 100 μs-100 s | | to temporary |
| | | | | | aggegregation |
| AC | Lower: 2-5 kilovolt/cm | Continuous | Higher: | Parallel to | Decrease in |
| | | | >100 Hz | flow | viscosity due |
| | | | | | to temporary |
| | | | | | aggegregation |

*Quincke-rotation is the electrostatic field-induced motion of particles immersed in a liquid medium.

The table provided below includes the different variables the invention envisions as possible and useful when manipulating the viscosity of a confection composition using a magnetic field along with the expected effect.

| Magnetic Field | | | | | |
|---|---|---|---|---|---|
| | | Magnetic | | | |
| | Magnetic | field | | Magnetic | |
| Magnetic | field | application | Pulse | field | Expected |
| field type | strength | duration | frequency | orientation | Effect |
| DC or AC | 0.01-2 | Continuous | Low | Perpendicular | Increase in |
| | Tesla | | | to flow | viscosity due |
| | | | | | to magneto- |
| | | | | | rheological |
| | | | | | effect |
| DC | 0.01-2 | Pulsed | Single pulse | Parallel to | Decrease in |
| | Tesla | | of duration | flow | viscosity due |
| | | | 100 μs-100 s | | to temporary |
| | | | | | aggegregation |
| AC | 0.01-2 | Continuous | High | Parallel to | Decrease in |
| | Tesla | | | flow | viscosity due |
| | | | | | to temporary |
| | | | | | aggegregation |

In order to manipulate viscosity it is expected that the exposure period is suitably in the range of from about 0.1 second to about 20 minutes, about 0.5 seconds to 10 minutes, about 1 second to 5 minutes, about for example, from about 10 seconds to about 5 minutes, about 3 minutes to 5 minutes.

The electromagnetic radiation exposure according to the invention may depend upon the size and content of the particles in the confection. As previously described, confection compositions of the invention are comprised of a fat continuum in which solid particles are suspended. When a confection composition includes high protein particles having large particle size a direct current, high or low strength continuous or pulsed source of radiation may be applied. When one is manipulating the viscosity of a confection composition having high protein content particles of small particle size a direct current, high or low strength continuous or pulsed source of radiation may be applied, in the case of low protein content particles suspended in a fat continuum having large particle sizes a direct current, high or low strength continuous or pulsed source of radiation may be applied. When a confection composition includes primarily low protein content particles having small particle size a direct current, high or low strength continuous or pulsed source of radiation may be applied.

The invention, in one aspect, is practiced on confectionery compositions having an average solid particle suspended in the fat continuum of size ranging from 0.1 to 100 microns. It is believed that compositions having an average solid particle size will respond to radiation exposure in a manner allowing manipulation of the viscosity of the fluid confection. That is, compositions having average particle sizes within the range of 0.1 to 100 microns will respond to viscosity manipulation via electromagnetic radiation. One skilled in the art recognizes that an average particle size allows for a composition having particles much larger and much smaller than stated. One skilled in the art will recognize that the term “diameter” historically refers to particles having spherical shapes; however, the invention envisages that not all particles suspended in confectionery compositions or chocolate compositions as the case may be will be “spherical,” When the particles are globular or jagged or any shape other than spherical, “diameter” as used herein refers to the overall average diameter of the particle. For the purposes of explanation only, in the case of an ellipsoidal particle having a longer diameter across the length and a shorter diameter across the length, the “diameter” of particle having such an elliptical configuration would be the sum of the two diameters divided by two.

By applying electromagnetic energy to a confection composition, it is hypothesized that nearby polar particles such as milk proteins and/or sugar, tend to aggregate into larger particles. As the average particle size increases, the viscosity is reduced. And so, in embodiments wherein viscosity reduction is desired, it may be desirable to limit the applied field strength and time to that which results in the formed aggregates being, e.g., on the order of micrometers in size. On the other hand, if increased viscosity is desired, it may be appropriate to apply a stronger field strength or the same field strength for a longer period of time, so that macroscopic aggregates are formed.

The invention provides a system for manipulating the viscosity of confection compositions. When electrical fields are used according to the invention, the systems include an electric field generator, an electrical field applicator, and a viscosity manipulation chamber. An electrical field generator according to the invention generates an electrical field with a strength of from about 3 kilovolts/cm to about 25 kilovolts/cm. The electrical field applicator may apply the electrical field to the viscosity manipulation channel continuously or discontinuously. In an embodiment the confection composition has a protein content of from about 5 weight to about 9 weight %.

The invention provides a system for manipulating the viscosity of confection compositions. When magnetic fields are used according to the invention, the systems include an magnetic field generator, an magnetic field applicator, and a viscosity manipulation chamber. An magnetic field generator according to the invention generates an magnetic field with a strength of from about 0.01 Tesla to about 2 Tesla. The magnetic field applicator may apply the magnetic field to the viscosity manipulation channel continuously or discontinuously. In an embodiment the confection composition has a protein content of from about 5 weight % to about 9 weight %.

The electromagnetic radiation can be supplied by any suitable means, and many of these are known to those of ordinary skill in the art. In some embodiments, the electromagnetic radiation is supplied using a capacitor. The capacitor may be of any type suitable to apply such an electric field to a confection fluid. Suitable examples include at least two metallic meshes surrounding, or within, a conduit. Alternatively, a lead may be placed on either side of a conduit so that electric/electromagnetic field is created across the leads while a voltage potential is maintained. The confection, or precursor, is then caused to pass through the conduit, experiencing a short pulse electric field as a constant voltage is applied to the capacitor. In another embodiment mesh may be placed across the confection conduit and the confection passes through the mesh webbing.

Other types of capacitors may also be used to practice the present invention. The radiation source may be applied in a parallel or in a perpendicular orientation in relation to the flow of the confection composition. In one embodiment the field is applied in a direction parallel to the direction of fluid flow. This type of capacitor can be used to generate pulse fields that can be applied to the fluid confection. In yet another embodiment, the field may be generated by a capacitor across which the field is applied in a direction perpendicular to the flow of the confection fluid. It is contemplated that the field can be applied in almost any feasible direction across the confection or precursor and still provide a desired result.

After exposure to the electromagnetic radiation, the viscosity of the confection or precursor thereof will tend to return toward its original value. In order to maintain a desired viscosity range, it may be desirable to re-expose the confection to the electromagnetic radiation periodically. In some embodiments, such re-exposure can be readily implemented by passing the confection through a conduit, or passing it via some other conveyance, having sources of the electromagnetic radiation operably disposed at appropriate intervals along the conduit or conveyance. For example, it may be desirable to reapply the electric field at intervals ranging, for example, from about 1 minute to about 20 minutes as the confection fluid progresses along its path of travel to ensure that desired effect of the electromagnetic radiation is substantially maintained.

Once the field is removed, the rate that the viscosity returns to its original value decreases over time. As previously described, and while not wishing to be bound by any theory, it is believed that applying electric or magnetic fields to the confection or precursor results in aggregation of particles in the confection or precursor. It is further believed that once the source of electromagnetic radiation is removed, the aggregated particles formed during application of the radiation gradually disassemble. The return of the confection or precursor to its original viscosity may depend upon Brownian motion time-scales. Typically, and depending on the size and number of the aggregates, the fluid confection may retain its altered viscosity for minutes up to several hours, returning to its initial value after 30 minutes, one hour, two hours, three hours, four hours, or More.

The viscosity altering effect that is experienced by the confection or precursor may be adjusted or enhanced by applying one or more mechanical manipulations to the confection before, during, or after exposure to the electromagnetic field. Such mechanical manipulation includes but is not limited to agitating the confection as by vibrating, stirring, pumping or conching continuously, or in pulses. However, a particular advantage of the present process is that mechanical intervention, thermal intervention, and compositional intervention are not required to manipulate the rheological properties of the confection, and although such mechanical manipulations can be performed within the process as conventional, they are not necessary to the operability of the process. Rather, any additional mechanical manipulations performed to enhance the impact of exposure to the electromagnetic field are purely optional.

In some embodiments, the frequency and/or amplitude of the electric and/or magnetic waves may be adjusted during each exposure, or to be different during different exposure periods, to optimize results. Any such adjustment will contemplate the physical properties of the confection. For example, a certain fluid confection may require applying high amplitude and low frequency waves while another may require applying high frequency and low amplitude waves.

The temperature and/or viscosity of the confection when exposed to the electromagnetic radiation can impact the magnitude of the impact of the radiation on the confection. That is, the application of the field to the confection has a greater or lesser impact depending upon the pre-exposure temperature and/or viscosity of the confection. One skilled in the art can appreciate that at lower temperatures/higher viscosities, a greater change in the temperature/viscosity is possible than at higher temperatures/lower viscosities, in particular if a decrease in viscosity is desired. The opposite may be true if an increase in viscosity is desired, i.e., exposing the confection to electromagnetic radiation when at higher temperatures and lower viscosities is likely to produce a smaller change than if an increase in viscosity is desired in a confection with a lower temperature and/or higher viscosity.

An apparatus for the exposure of a confection composition or precursor thereof to electromagnetic radiation is also contemplated. The apparatus comprises a plurality of devices for producing at least one of electric, magnetic, and/or electromagnetic field spaced along a conduit, or other conveyance, for transporting a confection. Or, the devices may be operably disposed relative to a vessel containing the confection. Another apparatus unique to confectionery processing is provided, and may be, e.g., a roll refiner and/or a conching device.

In another embodiment, a plurality of devices (electromagnetic field generators) may be used and be attached to electromagnetic field applicators and arranged about the confection composition, or the vessel or conduit containing the confection (viscosity manipulation chamber), in a two-dimensional array of alternating electrodes at different electric potentials. Suitable devices include electrodes, leads, webbing, mesh, electromagnets, etc., or combinations of any number of these. The field strength applied by each device can be the same or different, as can the length of time the field is applied, and are determined relative to one another, as well as in light of the current properties, e.g., temperature and viscosity, of the confection to be exposed. The devices may be disposed within a conduit through which the confection composition flows.

In operation of the apparatus, as the confection is transported through a conduit, or along a conveyance having at least two, e.g., leads or electrodes operatively disposed relative thereto, the at least two leads apply a field through the confection, thereby exposing it to electromagnetic radiation. The field is generated by applying an electric potential difference between the at least two leads or electrodes. The electric potential difference applied may be pulsed, i.e., may be applied for a first time period and discontinued for a second time period, and this sequence repeated one or more times. The electric field may be modulated upwardly or downwardly as required or desired for a particular confection, as may either or both of the time periods. The time periods may be of the same length, or different.

Advantages of employing the present invention to manipulate the rheological characteristics of a confection are numerous. First, any change in one or more characteristics is temporary and reversible. Second, the process does not require increasing or reducing the temperature of the confection. Third, the process does not require the composition of the confection to be changed, e.g., as by addition of thickening or thinning agents. Finally, the process requires minimal capital expenditure, may readily be incorporated into an existing process an onto existing equipment, and requires minimal energy consumption.

### Example 1

A DC electric field of 1 KiloVolt/cm is applied to a molten chocolate parallel to the direction of flow for 60 seconds. The molten chocolate is obtained by melting commercially available chocolate bars over a double boiler. The molten chocolate has an average particle size of 0.1 to 100 microns and an overall protein content of between 5 and 9 weight percent and an initial viscosity at ambient temperature (70° F., 21° C.). After exposure to the electric field, the viscosity of the molten chocolate will decrease to about 20% of its initial value. After the electric field is removed, the viscosity will increase to its original viscosity over time. After about 30 minutes, the viscosity of the molten chocolate will increase to be within about 5% of the original viscosity. The rate of viscosity increase after the first 30 minute application period is expected to drop considerably.

### Example 2

A DC electric field of 1 KiloVolt/cm is applied to a molten chocolate perpendicular to the direction of flow for 60 seconds. The molten chocolate is obtained by melting commercially available chocolate bars over a double boiler. The molten chocolate has an average particle size of 0.1 to 100 microns and an overall protein content of between 2 and 9 weight percent and an initial viscosity at ambient temperature F, 21° C.). After exposure to the electric field, the viscosity of the molten chocolate will increase by about 20% of its initial value. After the electric field is removed, the viscosity will decrease to its original viscosity over time. After about 30 minutes, the viscosity of the molten chocolate will decrease to be within about 5% of the original viscosity. The rate of viscosity decrease after the first 30 minute application period is expected to drop considerably.

### Example 3

A DC electric field of 1 KiloVolt/cm is applied to a molten caramel parallel to the direction of flow for 60 seconds. The molten caramel is obtained by melting commercially available caramels over a double boiler. The molten caramel has an average particle size of 0.1 to 100 microns and an overall protein content of between 2 and 9 weight percent and an ial viscosity at ambient temperature (70° F., 21° C.). After exposure to the electric field, the viscosity of the molten caramel will decrease to about 20% of its initial value. After the electric field is removed, the viscosity will increase to its original viscosity over time. After about 30 minutes, the viscosity of the molten caramel will increase to be within about 5% of the original viscosity. The rate of viscosity increase after the first 30 minute application period is expected to drop considerably.

### Example 4

A DC electric field of 1 KiloVolt/cm is applied to a molten caramel perpendicular to the direction of flow for 60 seconds. The molten caramel is obtained by melting commercially available caramels over a double boiler. The molten caramel has an average particle size of 0.1 to 100 microns and an overall protein content of between 2 and 9 weight percent and an initial viscosity at ambient temperature (70° F., 21° C.). After exposure to the electric field the viscosity of the molten caramel will increase by about 20% of its initial value. After the electric field is removed, the viscosity will decrease to its original viscosity over time. After about 30 minutes, the viscosity of the molten caramel will decrease to be within about 5% of the original viscosity. The rate of viscosity decrease after the first 30 minute application period is expected to drop considerably.

### Example 5

An 1 KiloHz/cm AC electric field is applied to each of a fluid caramel and a molten chocolate for 30 seconds each in a direction parallel to the flow of the confection composition. As in the Examples above, the fluid caramel and molten chocolate are obtained by melting commercially purchased chocolate bars and caramels over double boilers. Each of the fluid confections would have an initial viscosity at ambient temperature (70° F., 21° C.). After exposure to the electric field, the viscosity of each of the molten chocolate and the fluid caramel will decrease to about 20% of its initial value. After the electric field is removed, the viscosity will increase to its original viscosity. After about 30 minutes, the viscosity will climb to be within about 5% below the original viscosity. The rate of viscosity increase after the first 30-minute period is expected to drop considerably.

### Example 6

An 1 KiloHz/cm AC electric field is applied to each of a fluid caramel and a molten chocolate for 30 seconds each in a direction perpendicular to the flow of the confection composition. As in the Examples above, the fluid caramel and molten chocolate are obtained by melting commercially purchased chocolate bars and caramels over double boilers. Each of the fluid confections would have an initial viscosity at ambient temperature (70° F., 21° C.). After exposure to the electric field, the viscosity of each of the molten chocolate and the fluid caramel will increase to about 20% of its initial value. After the electric field is removed, the viscosity will decrease to its original viscosity. After about 30 minutes, the viscosity will drop to be within about 5% above the original viscosity. The rate of viscosity decrease after the first 30-minute period is expected to drop considerably.

The results as shown in Examples 5 and 6 would indicate that both DC electric fields and low-frequency AC fields are effective in reducing or increasing the apparent viscosity of the fluid confection samples tested depending upon the direction of application of the electromagnetic field relative to the direction of flow of the confection composition.

### Example 7

A DC electric field of 3 KiloVolt/cm is applied to a molten chocolate in pulses at a frequency of 2 pulses per second for 60 seconds in a direction parallel to the flow of the chocolate. The molten chocolate is obtained by melting commercially available chocolate bars over a double boiler as provided above in Example 1. The molten chocolate would have an initial viscosity at ambient temperature (70° F., 21° C.). After exposure to the electric field, the viscosity of the molten chocolate will decrease in relation to its initial value. After the electric field is removed, the viscosity will increase to its original viscosity. After about 30 minutes, the viscosity will increase to be within about 25% above its original viscosity. The rate of viscosity increase after the first 30-minute period is expected to drop considerably.

### Example 8

A DC electric field of 3 KiloVolt/cm is applied to fluid caramel in pulses at a frequency of 2 pulses per second for 60 seconds in a direction parallel to the flow of the caramel. The fluid caramel is obtained by melting commercially available caramels bars over a double boiler. The fluid caramel would have an initial viscosity at ambient temperature (70° F., 21° C.). After exposure to the electric field, the viscosity of the caramel will decrease in relation to its initial value. After the electric field is removed, the viscosity will increase to its original viscosity. After about 30 minutes, the viscosity will increase to be within about 25% above its original viscosity. The rate of viscosity increase after the first 30-minute period is expected to drop considerably.

### Example 8

A magnetic field of 1 Tesla is applied to a molten tempered chocolate parallel to the direction of flow for 60 seconds. The molten chocolate is obtained by melting commercially available chocolate bars over a double boiler. The molten chocolate has an average particle size of 0.1 to 100 microns and an overall protein content of between 2 and 9 weight percent and an initial viscosity at ambient temperature (70° F., 21° C.). After exposure to the magnetic field, the viscosity of the molten chocolate will decrease to about 20% of its initial value. After the magnetic field is removed, the viscosity will increase to its original viscosity over time. After about 30 minutes, the viscosity of the molten chocolate will increase to be within about 5% of the original viscosity. The rate of viscosity increase after the first 30 minute application period is expected to drop considerably.

### Example 9

A magnetic field of 1 Tesla is applied to a molten untempered chocolate parallel to the direction of flow for 60 seconds. The molten chocolate is obtained by melting commercially available chocolate bars over a double boiler. The molten chocolate has an average particle size of 0.1 to 100 microns and an overall protein content of between 2 and 9 weight percent and an initial viscosity at ambient temperature (70° F., 21° C.). Application of a magnetic field to untempered chocolate does not have any effect on the viscosity of the molten chocolate.

### Example 10

A magnetic field of 1 Tesla is applied to a fluid caramel parallel to the direction of flow for 60 seconds. The fluid caramel is obtained by melting commercially available caramels over a double boiler. The fluid caramel has an average particle size of 0.1 to 100 microns and an overall protein content of between 2 and 9 weight percent and an initial viscosity at ambient temperature (70° F., 21° C.). Application of a magnetic field to fluid caramel does not have any effect on the viscosity of the fluid caramel.

While typical aspects of embodiment and/or embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention. It should be understood that all such modifications and improvements have been deleted herein for the sake of conciseness and readability but are properly within the scope of the following claims.

1. A system for manipulating the viscosity of confection compositions, comprising:
an electrical field generator, an electrical field applicator, and a viscosity manipulation chamber:
wherein the electrical field generator generates an electrical field with a strength of from about 1 kilovolts/cm to about 25 kilovolts/cm;
and wherein the electrical field applicator applies the electrical field to the viscosity manipulation channel continuously;
and wherein the confection composition has a protein content of from about 4% to about 9%.

2. The system of claim 1, wherein the confection composition is comprised of about 20 weight percent to about 40 weight percent of a fat continuum and about 60 weight percent to about 80 weight percent suspended solids; wherein the suspended solids is comprised of protein, sugar, and nonfat cocoa solids or any combination thereof and the fat continuum is comprised of cocoa butter, milk fat, and vegetable fat or any combination thereof.

3. The system of claim 2 wherein the suspended solids have an average diameter of between about 0.1 to about 100 microns.

4. The system of claim 1 wherein the electrical field applicator applies an electrical field to the confection composition in a direction that is perpendicular to a flow of a confection composition located in the viscosity manipulation chamber.

5. The system of claim 1 wherein the electrical field applicator applies an electrical field to the confection composition in a direction that is parallel to a flow of a confection composition located in the viscosity manipulation chamber.

6. A system for manipulating the viscosity of confection compositions comprising an electrical field generator, an electrical field applicator, and a viscosity manipulation chamber;
wherein the electrical field generator generates an electrical field with a strength of from about 1 kilovolts/cm to about 25 kilovolts/cm;
and wherein the electrical field applicator applies the electrical field to the viscosity manipulation channel as pulses occurring with a frequency of 2 pulses every second for from about 10 to about 15 seconds;
and wherein the confection composition has a protein content of from about 4% to about 9%.

7. The system of claim 6, wherein the confection composition is comprised of about 20 weight percent to about 40 weight percent of a fat continuum and about 60 weight percent to about 80 weight percent suspended solids; wherein the suspended solids is comprised of protein, sugar, and nonfat cocoa solids or any combination thereof and the fat continuum is comprised of cocoa butter, milk fat, and vegetable fat or any combination thereof.

8. The system of claim 7 wherein the suspended solids have an average diameter of between about 0.1 to about 100 microns.

9. The system of claim 6 wherein the electrical field applicator applies an electrical field to the confection composition in a direction that is perpendicular to a flow of a confection composition located in the viscosity manipulation chamber.

10. The system of claim 6 wherein the electrical field applicator applies an electrical field to the confection composition in a direction that is parallel to a flow of a confection composition located in the viscosity manipulation chamber

11. A system for manipulating the viscosity of confection compositions, comprising: a magnetic field generator, a magnetic field applicator, and a magnetic manipulation chamber;
wherein the magnetic field generator generates an magnetic field with a strength of from about 0.01 Tesla to about 2 Tesla;
and wherein the magnetic field applicator applies the magnetic field to the viscosity manipulation channel continuously;
and wherein the confection composition has a protein content of from about 4% to about 9%.

12. The system of claim 11, wherein the confection composition is comprised of about 20 weight percent to about 40 weight percent of a fat continuum and about 60 weight percent to about 80 weight percent suspended solids; wherein the suspended solids is comprised of protein, sugar, and nonfat cocoa solids or any combination thereof and the fat continuum is comprised of cocoa butter, milk fat, and vegetable fat or any combination thereof.

13. The system of claim 12 wherein the suspended solids have an average diameter of between about 0.1 to about 100 microns.

14. The system of claim 11 wherein the magnetic field applicator applies a magnetic field to the confection composition in a direction that is perpendicular to a flow of a confection composition located in the viscosity manipulation chamber.

15. The system of claim 11 wherein the magnetic field applicator applies a magnetic field to the confection composition in a direction that is parallel to a flow of a confection composition located in the viscosity manipulation chamber

16. A system for manipulating the viscosity of confection compositions comprising a magnetic field generator, a magnetic field applicator, and a viscosity manipulation chamber;
wherein the magnetic field generator generates an magnetic field with a strength of from about 0.01 to about 2 Tesla;
and wherein the magnetic field applicator applies the magnetic field to the viscosity manipulation channel as pulses occurring with a frequency of 2 pulses every second for from about 10 to about 15 seconds;
and wherein the confection composition has a protein content of from about 4% to about 9%.

17. The system of clan 16, wherein the confection composition is comprised of about 20 weight percent to about 40 weight percent of a fat continuum and about 60 weight percent to about 80 weight percent suspended solids; wherein the suspended solids is comprised of protein, sugar, and nonfat cocoa solids or any combination thereof and the fat continuum is comprised of cocoa butter, milk fat, and vegetable fat or any combination thereof.

18. The system of claim 17 wherein the suspended solids have an average diameter of between about 0.1 to about 100 microns.

19. The system of claim 16 wherein the magnetic field applicator applies the magnetic field in a direction that is perpendicular to a flow of a confection composition located in the viscosity manipulation chamber.

20. The system of claim 16 wherein the magnetic field applicator applies the magnetic field in a direction that is parallel to a flow of a confection composition located in the viscosity manipulation chamber.
